(19) United States
(12) Patent Application Publication
(10) Pub. No.: US 2021/0299810 A1
(43) Pub. Date: Sep. 30, 2021

(54) CUTTING EDGE MACHINING APPARATUS AND CUTTING APPARATUS

(71) Applicant: National University Corporation Tokai National Higher Education and Research System, Nagoya-shi (JP)

(72) Inventor: Eiji SHAMOTO, Nagoya-shi Aichi (JP)

(21) Appl. No.: 17/188,380

(22) Filed: Mar. 1, 2021

Related U.S. Application Data
(63) Continuation of application No. PCT/JP2020/014708, filed on Mar. 30, 2020.

(51) Int. Cl. B23Q 15/22; B23K 26/382; B23K 26/03; B23K 26/06

(52) U.S. Cl. CPC B23Q 15/22; B23K 26/0648; B23K 26/03; B23K 26/382

(57) ABSTRACT

A first optical member including a reflection mirror and a lens forms a first optical path of laser light. A second optical member including a reflection mirror, a lens, and a reflection mirror forms a second optical path of laser light. A motion mechanism moves a cutting edge of a cutting part relative to the first optical path and the second optical path. A controller causes the motion mechanism to move the cutting edge relative to the first optical path to machine a flank face of the cutting edge with laser light passing through the first optical path. The controller further causes the motion mechanism to move the cutting edge relative to the second optical path to machine a rake face of the cutting edge with laser light passing through the second optical path.

### CROSS-REFERENCE TO RELATED APPLICATIONS

This application is based upon and claims the benefit of priority from the International Application No. PCT/JP2020/014708, filed on Mar. 30, 2020, the entire contents of which are incorporated herein by reference.

### BACKGROUND

### 1. Field of the Disclosure

The present disclosure relates to a technique of machining a cutting part of a cutting tool with laser light.

### 2. Description of the Related Art

As a machining method using laser light, pulse laser grinding (PLG) is known in which surface machining is performed by concentrating pulse laser light and scanning a cylindrical irradiation region including a focused spot over a surface of a premachined object. JP 2016-159318 A discloses a method of overlapping an irradiation region of pulse laser light that extends in a cylindrical shape and has energy enough to make machining with a surface-side portion of a premachined object and scanning the irradiation region at a speed that allows machining to remove a surface region of the premachined object. Non Patent Literature 1, Hiroshi Saito, Hongjin Jung, Eiji Shamoto, Shinya Suganuma, and Fumihiro Itoigawa; “Mirror Surface Machining of Steel by Elliptical Vibration Cutting with Diamond-Coated Tools Sharpened by Pulse Laser Grinding”, International Journal of Automation Technology, Vol. 12, No. 4, pp.573-581 (2018), discloses a technique of machining a flank face of a tool base material in two directions by pulse laser grinding to form a V-shaped cutting edge.

### SUMMARY

FIGS. 1A and 1B are diagrams for describing a method of sharpening a cutting edge of a diamond-coated tool by pulse laser grinding disclosed in Non Patent Literature 1. FIG. 1A shows a state where a rake face is subjected to pulse laser grinding, and FIG. 1B shows a state where a flank face is subjected to pulse laser grinding in two directions. As disclosed in Non Patent Literature 1, the cutting edge is sharpened by causing laser light to slightly cut into the tool cutting edge and applying a feed motion along the cutting edge ridgeline between the laser light and the tool.

As shown in FIGS. 1A and 1B, in order to machine the rake face and flank face of the tool cutting edge using a single ray of laser light, it is necessary to change the orientation of the tool relative to the laser light. As disclosed in Non Patent Literature 1, a five-axis machine tool having three translation axes of XYZ and two rotation axes including A-axis and C-axis is used to change the tool orientation by a cutting-part angle (an angle between the rake face and the flank face after being machined). In order to machine the rake face and flank face of the tool cutting edge with a machining apparatus that uses a single ray of laser light as described above, a rotation control axis for changing the tool orientation is required.

The present disclosure has been made in view of such circumstances, and it is therefore one object of the present disclosure to provide a cutting edge machining technique that allows a reduction in the number of control axes. Further, another object of the present disclosure is to provide a cutting apparatus excellent in practicality.

In order to solve the above-described problem, a cutting edge machining apparatus according to one aspect of the present disclosure is structured to laser-machine a cutting part of a cutting tool and includes a first optical member structured to form a first optical path of laser light, a second optical member structured to form a second optical path of laser light, a motion mechanism structured to move a cutting edge of the cutting part relative to the first optical path and the second optical path, and a controller structured to control relative movement made by the motion mechanism. The controller causes the motion mechanism to move the cutting edge relative to the first optical path to machine a flank face of the cutting edge with laser light passing through the first optical path. The controller further causes the motion mechanism to move the cutting edge relative to the second optical path to machine a rake face of the cutting edge with laser light passing through the second optical path.

Another aspect of the present disclosure is a cutting apparatus. This apparatus includes a motion mechanism structured to move a cutting edge of a cutting tool relative to a workpiece, and a controller structured to control movement, made by the motion mechanism, of the cutting edge of the cutting tool relative to the workpiece. The cutting apparatus further includes a laser light source structured to emit laser light for use in laser-machining the cutting edge of the cutting tool, and an optical member structured to form an optical path of laser light. The controller causes the motion mechanism to move the cutting edge relative to the optical path to laser-machine the cutting edge.

### BRIEF DESCRIPTION OF THE DRAWINGS

FIG. 1A and 1B are diagrams for describing a method of sharpening a cutting edge of a diamond-coated tool.

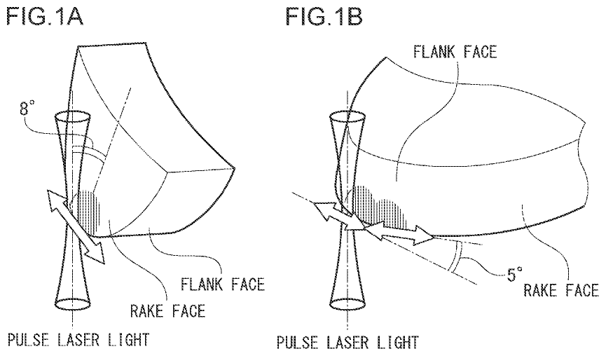

FIG. 2 is a diagram for describing pulse laser grinding.

FIG. 3 is a diagram showing a cutting edge machining apparatus.

FIG. 4 is a diagram showing a state where a cutting part has entered a laser unit.

FIG. 5 is a diagram showing an internal structure of the laser unit.

FIG. 6 is a diagram showing a cutting apparatus that integrates with the laser unit.

FIG. 7 is a top view of an integrated part.

FIG. 8 is a diagram showing a state where the cutting edge is cutting a workpiece.

FIG. 9 is a diagram showing a state where the cutting edge is cutting the workpiece.

FIG. 10 is a diagram showing a state where the cutting part has entered the laser unit.

FIG. 11 is a diagram showing a state where the cutting part has entered the laser unit.

FIG. 12 is a diagram showing a structure of an ultrasonic elliptical vibration cutting tool.

### DETAILED DESCRIPTION

The disclosure will now be described by reference to the preferred embodiments. This does not intend to limit the scope of the present disclosure, but to exemplify the disclosure.

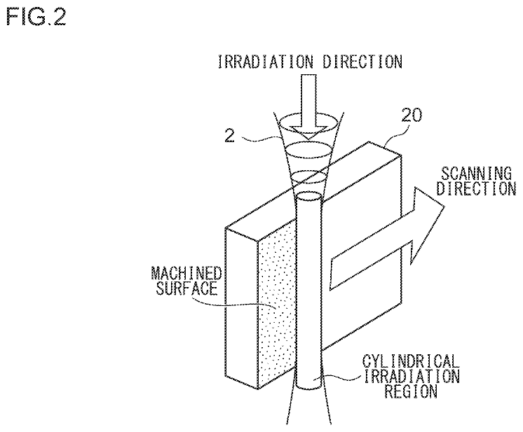

FIG. 2 is a diagram for describing pulse laser grinding. As disclosed in JP 2016-159318 A and Non Patent Literature 1, the pulse laser grinding is a machining method of overlapping a cylindrical irradiation region extending in an optical axis direction of laser light 2 and having energy enough to make machining with a surface of a premachined object 20 and scanning the cylindrical irradiation region in a direction intersecting the optical axis to remove a surface region of the premachined object 20 where the cylindrical irradiation region has passed. In the pulse laser grinding, a plane parallel to the optical axis direction and scanning direction is formed on the surface of the premachined object 20.

Structure of Cutting Edge Machining Apparatus

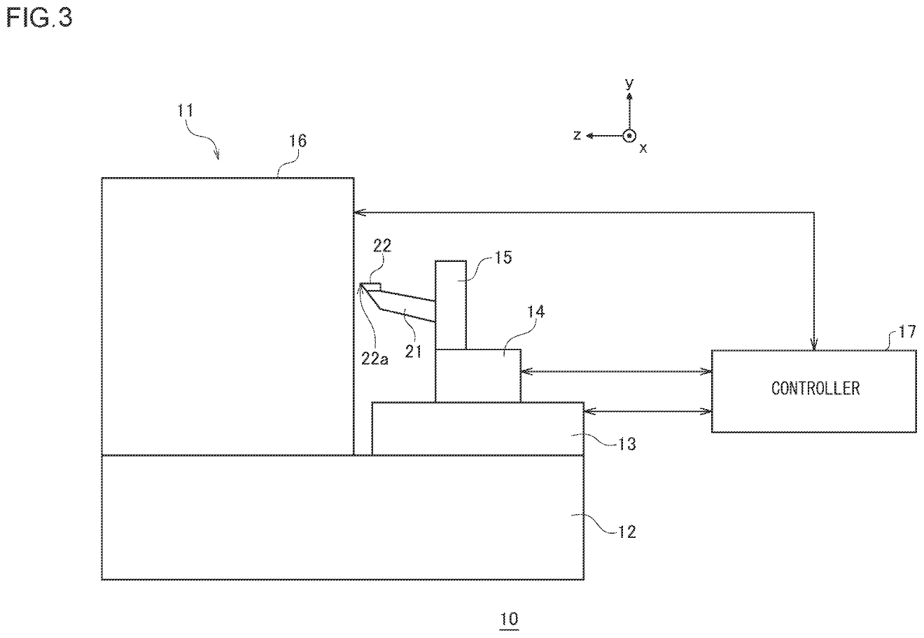

FIG. 3 shows a cutting edge machining apparatus 10 that laser-machines a cutting part of a cutting tool. The cutting edge machining apparatus 10 includes a laser-machining part 11 and a controller 17. The controller 17 may be a numerical control (NC) control device that controls the laser-machining part 11 in accordance with an NC program. In the cutting edge machining apparatus 10, the laser-machining part 11 and the controller 17 may be separately provided and be connected to each other by a cable or the like, or alternatively, may be integrated into a single device.

The laser-machining part 11 includes a bed 12 serving as a base, and a first table 13 and a second table 14 movably supported on the bed 12. The first table 13 is supported movable in an X-axis direction by a rail provided on the bed 12, and the second table 14 is supported movable in a Z-axis direction by a rail provided on the first table 13. A tool holder 15 to which a premachined object is attached is provided on an upper surface of the second table 14, and according to the embodiment, attached to the tool holder 15 is a cutting tool 21 having a cutting part 22 to be laser-machined. The cutting part 22 has a cutting edge 22a with a flank face and a rake face for use in cutting a workpiece.

A laser unit 16 is capable of irradiating the cutting edge 22a of the cutting part 22 with two rays of laser light to sharpen the cutting edge 22a. The laser unit 16 according to the embodiment is a pulse laser grinder that overlaps a cylindrical irradiation region including a focused spot of laser light with the flank face of the cutting edge 22a and the rake face of the cutting edge 22a at the same timing or at different timings and scans the cylindrical irradiation region in a direction intersecting an optical axis of the laser light to remove a surface region through which the cylindrical irradiation region has passed, or alternatively, may be a laser machine tool that uses a different irradiation method.

The first table 13 and the second table 14 serve as a motion mechanism that moves the cutting edge 22a of the cutting part 22 relative to a laser optical path in the laser unit 16. Although not shown, the first table 13 and the second table 14 are each driven by an actuator such as a motor. Note that, according to the embodiment, the first table 13 and the second table 14 move the cutting tool 21 attached to the tool holder 15 in the X-axis direction and the Z-axis direction, but the cutting tool 21 only needs to be moved relative to the laser optical path in the laser unit 16. That is, the motion mechanism may move the laser optical path in the laser unit 16 relative to the cutting tool 21. As described above, it does not matter which of the cutting tool 21 and the laser optical path is moved as long as the relative movement in a movement direction is made.

During laser-machining, the controller 17 controls the movements of the first table 13 and the second table 14 in accordance with the NC program to regulate the relative movement between the cutting tool 21 and the laser optical path made by the motion mechanism. Further, during laser-machining process, the controller 17 regulates the irradiation of laser light in the laser unit 16. Note that the controller 17 may be capable of adjusting a position and orientation of an optical member in the laser unit 16 to make the laser optical path variable.

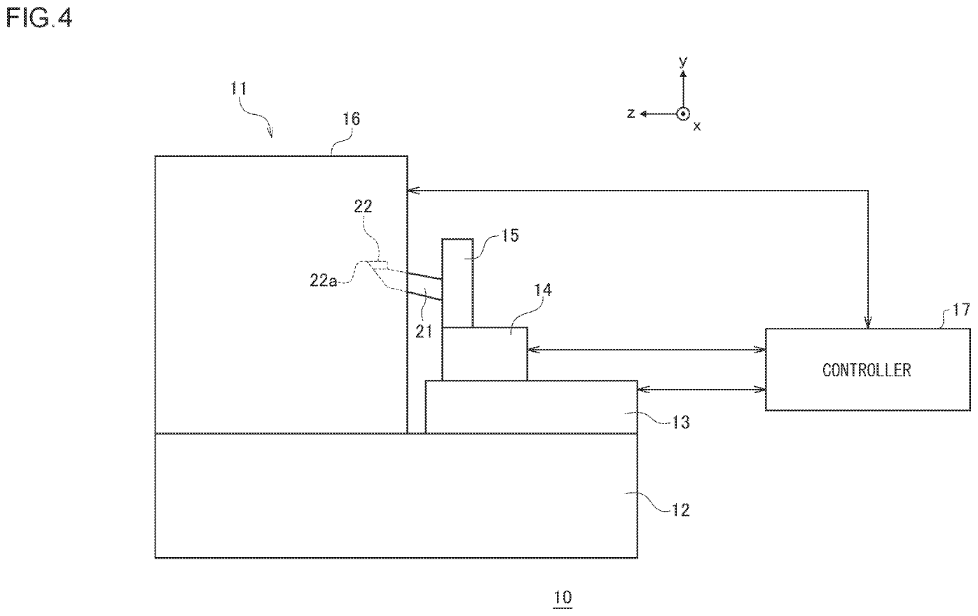

FIG. 4 shows a state where the cutting part 22 of the cutting tool 21 has entered the laser unit 16. Before laser-machining process, the controller 17 moves the second table 14 in a Z-axis positive direction to put at least a tip side of the cutting tool 21 into the laser unit 16 through an opening of the laser unit 16. Then, the controller 17 drives a laser light source in the laser unit 16 to emit laser light for use in machining the flank face of the cutting edge 22a and laser light for use in machining the rake face of the cutting edge 22a. Since the cutting edge machining apparatus 10 according to the embodiment machines the flank face of the cutting edge 22a and the rake face of the cutting edge 22a by using the two rays of laser light traveling in different directions, the cutting edge machining apparatus 10 has an advantage in that the orientation of the cutting tool 21 need not be changed between the machining of the flank face and the machining of the rake face, and no rotation control axis that changes the orientation of the tool is required.

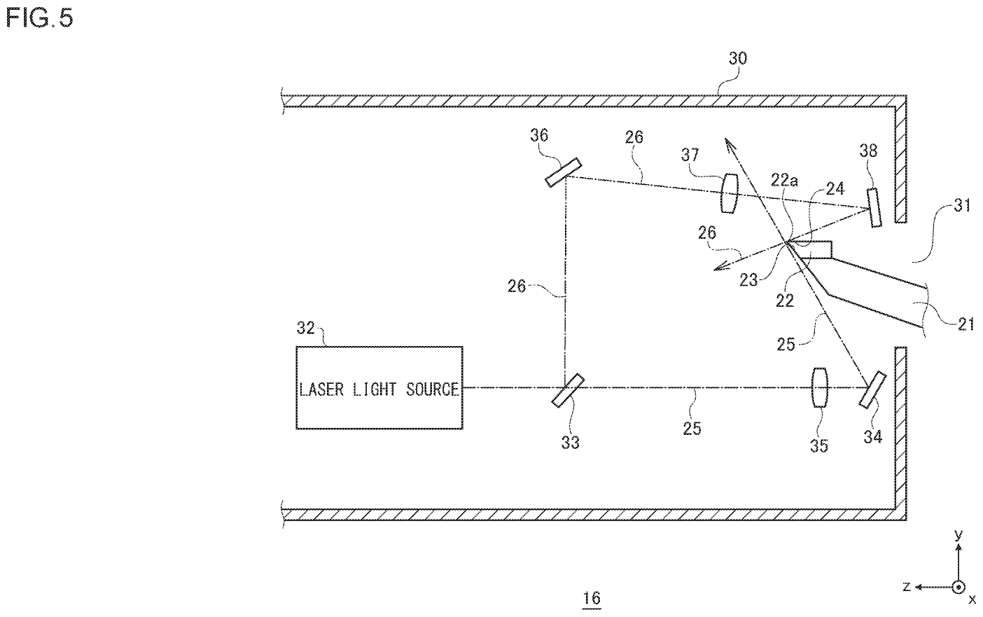

FIG. 5 shows an internal structure of the laser unit 16. The laser unit 16 includes a protective housing 30 having an opening 31, and a laser light source 32 and a plurality of optical members forming two laser optical paths are provided in the protective housing 30. The protective housing 30 prevents the laser light emitted by the laser light source 32 from leaking to the outside and prevents foreign matter from entering the laser unit 16. Note that, in order to prevent the leakage of light and the entrance of foreign matter more reliably, a mechanism that closes the opening 31 when laser-machining process is not under execution may be provided.

The laser light source 32 includes a laser oscillator that generates laser light, an attenuator that adjusts output of the laser light, a beam expander that adjusts a diameter of the laser light, and the like, and emits the laser light thus adjusted. The laser oscillator may generate, for example, Nd:YAG pulse laser light. A beam splitter 33 splits the laser light emitted from the laser light source 32 into two optical paths. As shown in FIG. 5, the laser light emitted from the laser light source 32 is split into two rays of light by the beam splitter 33, and the two rays of laser light are directed to the cutting edge 22a through different optical paths. The beam splitter 33 may be a half mirror.

A reflection mirror 34 and a lens 35 are optical members that form a first optical path 25 of laser light and direct light transmitting through the beam splitter 33 to a flank face 23 of the cutting edge 22a. A reflection mirror 36, a lens 37, and a reflection mirror 38 are optical members that form a second optical path 26 of laser light and direct light reflected off the beam splitter 33 to a rake face 24 of the cutting edge 22a. The lens 35 and the lens 37 each concentrate a corresponding ray of incident light to position the cylindrical irradiation region including the focused spot of the laser light at the cutting edge 22a. The lens 35 and the lens 37 may be lens systems each including a plurality of lenses. When viewed in the X-axis direction, an angle between the first optical path 25 and the second optical path 26 near the cutting edge 22a is set equal to an angle of the cutting part after being machined (an angle between the rake face and the flank face after being machined).

The controller 17 causes the motion mechanism to move the cutting edge 22a of the cutting tool 21 relative to the first optical path 25 and/or the second optical path 26 to machine the cutting edge 22a. In the example shown in FIG. 5, a cutting edge ridgeline of the cutting edge 22a extends in the X-axis direction, and, with the laser light passing through the first optical path 25 and/or the laser light passing through the second optical path 26 impinging on (applied to) the cutting edge 22a, moving the cutting edge 22a in the X-axis direction sharpens a tip of the cutting edge 22a.

Specifically, the controller 17 moves, with the laser light passing through the first optical path 25 that is approximately parallel to the flank face 23 of the cutting edge 22a applied to the flank face 23, the cutting edge 22a in the X-axis direction relative to the first optical path 25 to machine the flank face 23 of the tool cutting edge with the laser light passing through the first optical path 25. Further, the controller 17 moves, with the laser light passing through the second optical path 26 that is approximately parallel to the rake face 24 of the cutting edge 22a applied to the rake face 24, the cutting edge 22a in the X-axis direction relative to the second optical path 26 to machine the rake face 24 of the tool cutting edge with the laser light passing through the second optical path 26. As described above, the laser unit 16 according to the embodiment is capable of machining the flank face 23 and the rake face 24 with the rays of laser light passing through the two laser optical paths without changing the orientation of the cutting tool 21.

The controller 17 may cause the motion mechanism to simultaneously move the cutting edge 22a relative to the first optical path 25 and the second optical path 26 to simultaneously machine the flank face 23 and the rake face 24. Simultaneously machining the flank face 23 and the rake face 24 using the two rays of laser light brings about an advantage that the sharpening time can be shortened.

Note that the flank face 23 and the rake face 24 may be machined at different timings. It is known that the finishing accuracy of cutting using the cutting tool 21 provided with the cutting edge 22a depends on the surface roughness of the flank face 23 rather than the surface roughness of the rake face 24. Therefore, the rake face 24 may be machined first, and then the flank face 23 may be machined such that the flank face 23 is finished last.

In this case, first, the controller 17 causes the motion mechanism to move the cutting edge 22a relative to the second optical path 26 to machine the rake face 24. Since the laser light passing through the first optical path 25 is not used at this time, the controller 17 may block the laser light passing through the first optical path 25 with a light-shielding plate (not shown). Note that it is preferable that the light-shielding plate be provided between the beam splitter 33 and the lens 35 to block beam light before being concentrated. As described above, the rake face 24 of the tool cutting edge is machined first.

After the rake face 24 is machined, the controller 17 causes the motion mechanism to move the cutting edge 22a relative to the first optical path 25 to machine the flank face 23. Since the laser light passing through the second optical path 26 is not used at this time, the controller 17 may block the laser light passing through the second optical path 26 with a light-shielding plate (not shown). Note that it is preferable that the light-shielding plate be provided between the beam splitter 33 and the lens 37 to block the beam light before being concentrated. As described above, the flank face 23 of the tool cutting edge is machined, and the cutting edge machining is then completed.

As shown in FIG. 5, the rays of laser light passing through the first optical path 25 and the second optical path 26 each travel in a direction from a root side of the cutting part 22 toward a tip side of the cutting part 22. Results of performing pulse laser grinding under various conditions show that the laser light applied from the root side of the cutting part 22 toward the tip side of the cutting part 22 brings about a flat surface with high accuracy as compared with the laser light applied from the tip side of the cutting part 22 toward the root side of the cutting part 22. Therefore, it is preferable that the traveling directions of the rays of laser light passing through the first optical path 25 and the second optical path 26 be each set to the direction from the root side of the cutting part 22 toward the tip side of the cutting part 22.

Note that, in order to direct the laser light from the root side of the cutting part 22 toward the tip side of the cutting part 22, it is necessary to avoid interference between the laser light and a part of the cutting tool 21 other than the cutting edge 22a, a jig part, and the like. When it is difficult to set the traveling directions of the rays of laser light passing through both the first optical path 25 and the second optical path 26 to the directions from the root side of the cutting part 22 toward the tip side of the cutting part 22 due to spatial restrictions, the traveling direction of one of the rays of laser light may be set to an opposite direction. When the traveling direction of one of the rays of laser light is set to the opposite direction, the controller 17 first machines the cutting edge using the laser light traveling from the tip side of the cutting part 22 toward the root side of the cutting part 22, and then machines the cutting edge using the laser light traveling from the root side of the cutting part 22 to the tip side of the cutting part 22. As a result, a blunt (slightly less sharp) portion formed due to the previous cutting edge machining can be removed by the following cutting edge machining to form a sharp cutting edge 22a.

The first optical path 25 and the second optical path 26 may change in direction of laser incident on the cutting edge 22a by changing mirror angles. In the example shown in FIG. 5, the direction of laser incident on the cutting edge 22a can be adjusted by changing arrangement angles of the reflection mirrors 34, 38. Further, in the above-described example, the laser light emitted from the single laser light source 32 is split into two rays of laser light by the beam splitter 33, but laser light sources may be individually provided for the first optical path 25 and the second optical path 26.

Cutting Apparatus Including Laser Unit 16

The cutting edge machining apparatus 10 is equipped with the laser unit 16 that performs the cutting edge machining using the two rays of laser light, thereby eliminating the need for a rotation control axis for use in changing the tool orientation and allowing a simple structure. Proposed below is a structure where the laser unit 16 is built into a cutting apparatus that performs cutting process on a workpiece. Since the cutting apparatus is provided with the laser unit 16, when the cutting edge 22a of the cutting part 22 of the cutting tool 21 is worn, the cutting part 22 is moved to the laser unit 16 for laser-machining process without detaching the cutting tool 21 from the cutting apparatus, so that the cutting edge 22a can be resharpened.

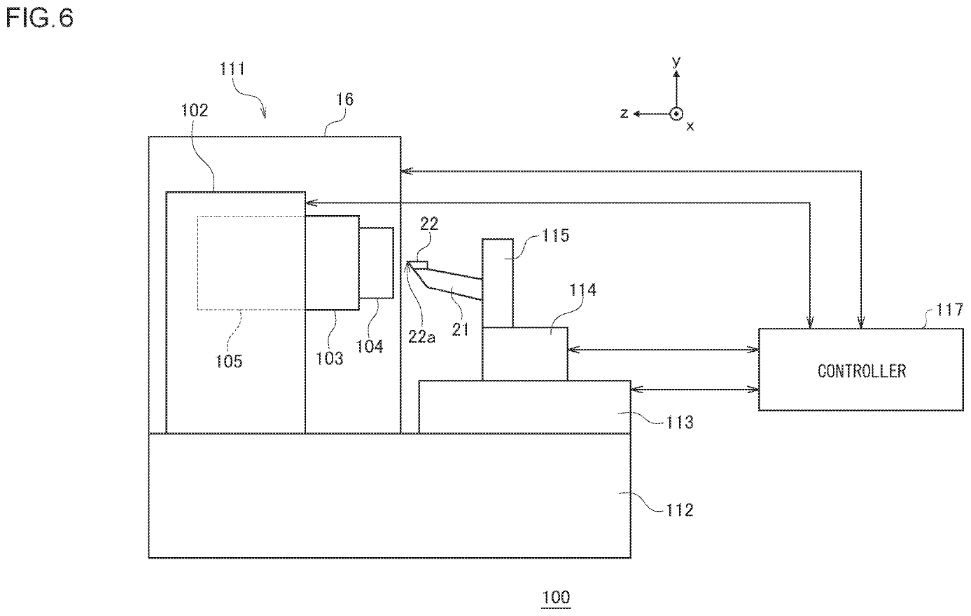

FIG. 6 shows a cutting apparatus 100 that is integrated with the laser unit 16 that laser-machines a cutting part of a cutting tool. The cutting apparatus 100 shown in FIG. 6 is a machining apparatus that causes the cutting edge 22a of the cutting tool 21 to cut into a workpiece 104 to turn the workpiece 104. The cutting apparatus 100 includes an integrated part 111 and a controller 117, and the controller 117 may be a numerical control (NC) control device that controls the integrated part 111 in accordance with an NC program. In the cutting apparatus 100, the integrated part 111 and the controller 117 may be separately provided and be connected to each other by a cable or the like, or alternatively, may be integrated into a single device.

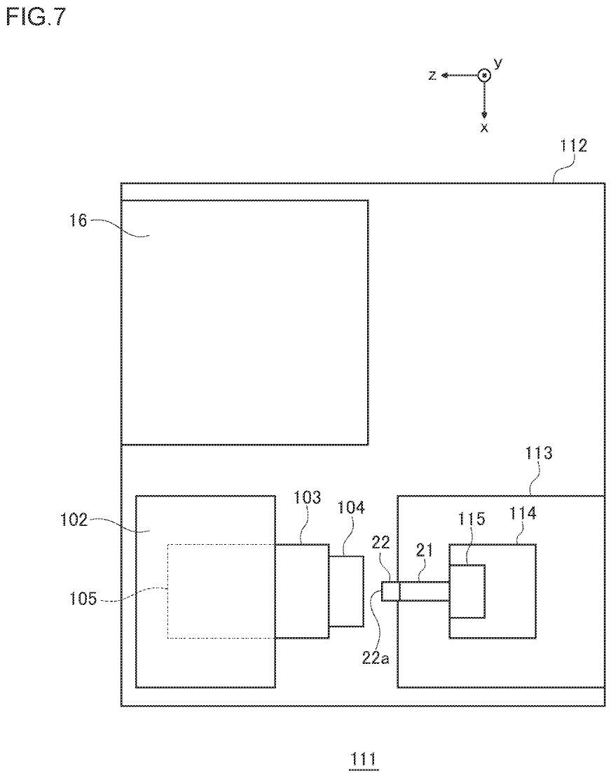

FIG. 7 shows a top view of the integrated part 111. The integrated part 111 includes a bed 112 serving as a base, and a first table 113 and a second table 114 are movably supported on the bed 112. The first table 113 is supported movable in the X-axis direction by a rail provided on the bed 112, and the second table 114 is supported movable in the Z-axis direction by a rail provided on the first table 113. A tool post 115 to which the cutting tool 21 is attached is provided on an upper surface of the second table 114. The cutting part 22 is fixed to the cutting tool 21, and the cutting part 22 has the cutting edge 22a provided at a tip of the cutting part 22, the cutting edge 22a having the flank face and the rake face for use in cutting the workpiece.

Provided above the bed 112 are a spindle 103 to which the workpiece 104 is attached and a headstock 102 that supports the spindle 103 rotatable. Provided in the headstock 102 is a rotation mechanism 105 that rotates the spindle 103. In order to cut the workpiece 104, the controller 117 drives the rotation mechanism 105 to rotate the spindle 103.

The first table 113 and the second table 114 serve as a motion mechanism that moves the cutting edge 22a of the cutting tool 21 relative to the workpiece 104. Although not shown, the first table 113 and the second table 114 are each driven by an actuator such as a motor. Note that, according to the embodiment, the first table 113 and the second table 114 move the cutting tool 21 attached to the tool post 115 in the X-axis direction and the Z-axis direction, but the cutting tool 21 only needs to be moved relative to the workpiece 104. That is, the motion mechanism may move the workpiece 104 relative to the cutting tool 21. As described above, it does not matter which of the cutting tool 21 and the workpiece 104 is moved as long as the relative movement in the movement direction is made.

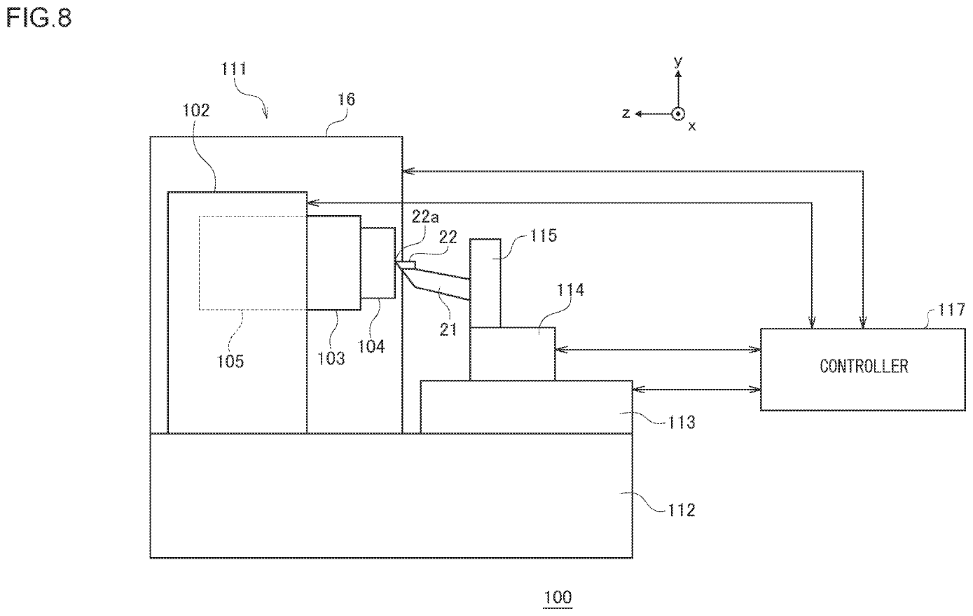

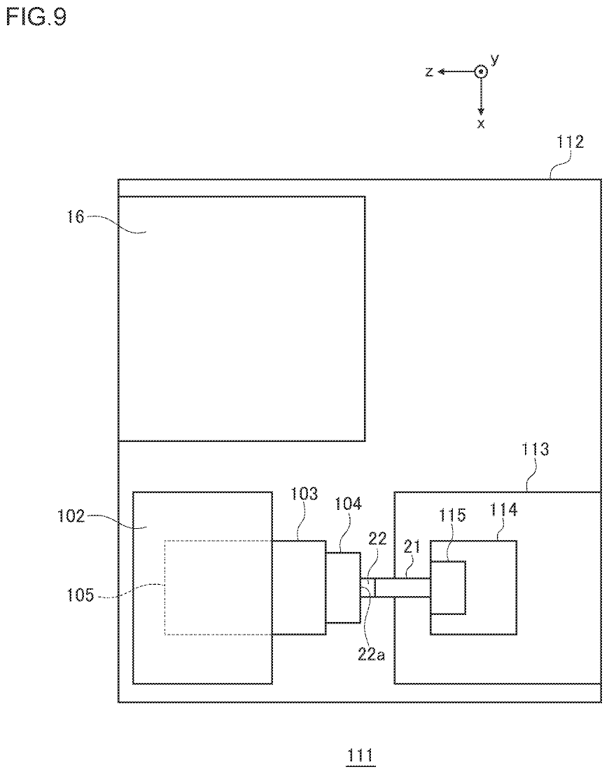

FIGS. 8 and 9 show a state where the cutting edge 22a of the cutting tool 21 cuts into the workpiece 104 to cut the workpiece 104. At the start of cutting process, the controller 17 rotates the rotation mechanism 105 and moves the second table 114 in the Z-axis positive direction to cause the cutting edge 22a of the cutting part 22 to cut into the workpiece 104. The controller 117 controls the movements of the first table 113 and the second table 114 in accordance with the NC program for cutting process to regulate the relative movement between the cutting tool 21 and the workpiece 104 made by the motion mechanism to cut the workpiece 104.

When cutting process with the cutting tool 21 is repeatedly performed in the cutting apparatus 100, the cutting edge 22a is sure to wear. Once the worn cutting tool 21 is detached from the cutting apparatus 100 and the cutting edge 22a is resharpened with a dedicated machine tool, it is necessary to measure and correct, for position calibration, an attachment error, and the like when the cutting tool 21 is attached again to the cutting apparatus 100.

Therefore, the integrated part 111 according to the embodiment includes, on the bed 112, the laser unit 16 capable of irradiating the cutting edge 22a of the cutting part 22 with two lays of laser light to sharpen the cutting edge 22a. The laser unit 16 may be a pulse laser grinder that overlaps a cylindrical irradiation region including a focused spot of laser light with the flank face of the cutting edge 22a and/or the rake face of the cutting edge 22a and scans the cylindrical irradiation region in a direction intersecting an optical axis of the laser light to remove a surface region through which the cylindrical irradiation region has passed, or alternatively, may be a laser machine tool that uses a different irradiation method. The controller 117 may estimate the degree of wear in the cutting edge 22a by measuring the cutting time and the like and determine to resharpen (perform sharpening process on) the cutting edge 22a when the degree of wear exceeds a predetermined threshold.

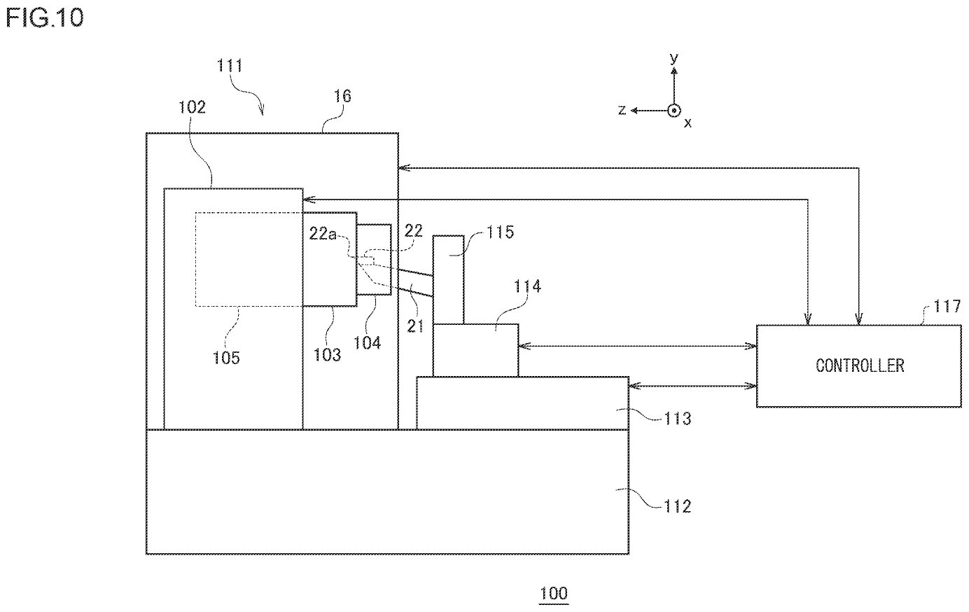

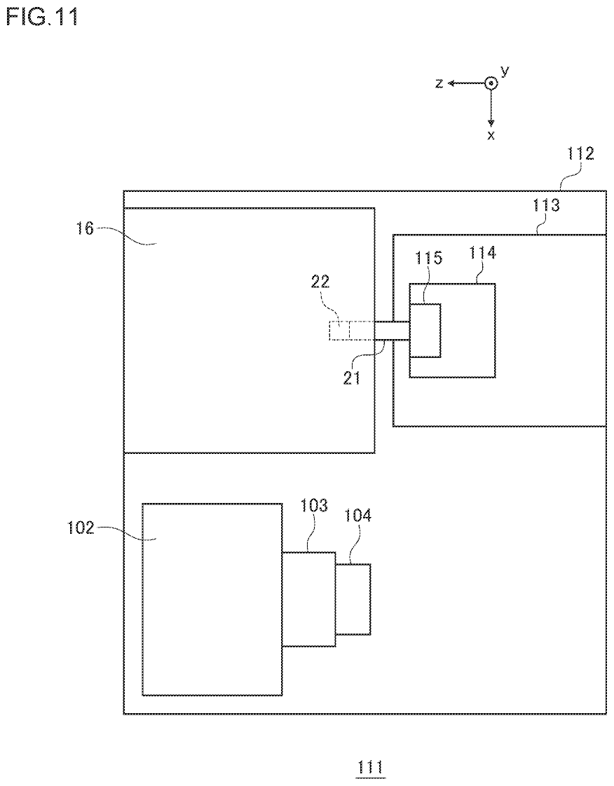

FIGS. 10 and 11 show a state where the cutting part 22 of the cutting tool 21 has entered the laser unit 16. At the end of cutting process, the first table 113 is located at the position in the X-axis direction shown in FIG. 7. When determining to sharpen the cutting edge 22a, the controller 117 moves the first table 113 in the X-axis negative direction to cause the cutting part 22 to face the opening 31 of the protective housing 30 (see FIG. 5). Subsequently, the controller 117 moves the second table 114 in the Z-axis positive direction to put at least the tip side of the cutting tool 21 into the laser unit 16 through the opening 31 of the laser unit 16. Then, the controller 117 drives the laser light source 32 in the laser unit 16 to cause the laser light source 32 to emit the laser light for use in machining the flank face of the cutting edge 22a and the laser light for use in machining the rake face of the cutting edge 22a. The sharpening process on the cutting edge 22a is as described with reference to FIG. 5.

In the cutting apparatus 100, the controller 117 causes the motion mechanism to put the tip side of the cutting tool 21 into the laser unit 16 while maintaining the cutting orientation of the cutting tool 21 and move the cutting tool 21 relative to the laser optical path to laser-machine the cutting edge 22a. In the cutting apparatus 100 according to the embodiment, the laser unit 16 is capable of irradiating the cutting edge 22a with two rays of laser light to sharpen the cutting edge 22a, which eliminates the need for changing the orientation of the cutting tool 21 during sharpening process and allows laser-machining process using the translation control axis used for cutting process.

For example, in spherical/aspherical turning, a round cutting tool with an arc-shaped cutting edge 22a are often used. During sharpening process on such a round cutting tool, referring to FIG. 5, the controller 117 may synchronously control the X-axis and Z-axis of the motion mechanism to move the cutting edge 22a relative to the laser optical path along the arc-shaped cutting edge ridgeline.

Note that when the cutting apparatus 100 includes a rotation control axis corresponding to the B-axis, it is desirable that laser-machining process be performed by rotating, after irradiating the cutting edge 22a with the laser light, the cutting edge 22a relative to the laser optical path about the center of the arc of the cutting edge 22a by B-axis control. Such machining allows, even when the intensity distribution of the laser light is not completely axisymmetric, the entire area of the cutting edge 22a to be machined at the same location in the circumferential direction of the laser light.

Although the case where the cutting apparatus 100 equipped with the laser unit 16 is a turning apparatus has been described above, the cutting apparatus 100 may be a different type of machining apparatus. A free-form surface machining apparatus creates a free-form surface on the workpiece attached to a work table, and the laser unit 16 may be provided side by side with the workpiece on the same work table. Note that it is also possible to fix the laser unit 16 to the bed 12 and separate the laser unit 16 from the work table. This is because the number of control axes for use in cutting process and the number of control axes for use in laser-machining process on the tool cutting edge need not necessarily be equal to each other.

Further, the cutting apparatus 100 may be an ultrasonic elliptical vibration cutting apparatus as disclosed in JP 2008-221427 A. Ultrasonic elliptical vibration cutting is a cutting method that enables ultra-precision fine cutting of high-hardness metals such as die steel.

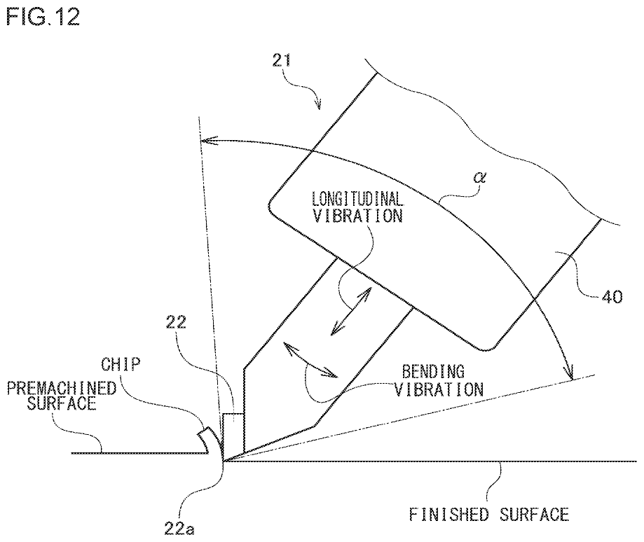

FIG. 12 shows a structure of an ultrasonic elliptical vibration cutting tool used in the ultrasonic elliptical vibration cutting apparatus. Since, in the cutting apparatus 100, the laser unit 16 machines the cutting edge 22a with the laser light traveling from the root side of the cutting part 22 toward the tip side of the cutting part 22 without changing the cutting tool orientation, it is necessary to avoid interference between the laser light and a part of the cutting tool 21 other than the cutting edge 22a, a jig part, and the like.

In the conventional ultrasonic elliptical vibration cutting tool, an ultrasonic vibrator is disposed on the extension line of the rake face, and when this ultrasonic elliptical vibration cutting tool is put into the laser unit 16, the ultrasonic vibrator interferes with the laser light traveling from the root side of the cutting part 22 toward the tip side of the cutting part 22. Therefore, for the ultrasonic elliptical vibration cutting tool mounted on the cutting apparatus 100, an ultrasonic vibrator 40 is disposed in a region defined between the extension line of the rake face of the cutting edge 22a and the extension line of the flank face of the cutting edge 22a.

Note that the ultrasonic elliptical vibration cutting apparatus that uses the ultrasonic elliptical vibration cutting tool shown in FIG. 12 requires a new control method for maintaining a vibration amplitude in a depth-of-cut direction constant, which is important for ultra-precision machining. This is because neither of the ultrasonic vibrations in two directions for use in generating elliptical vibrations coincides with the depth-of-cut direction. Therefore, the controller 117 performs the control of automatically tracking a resonance frequency of one vibration or a frequency between resonance frequencies in the two directions (weighted average) and calculating at least the amplitude in the depth-of-cut direction to maintain the amplitude in the depth-of-cut direction constant, thereby suppressing changes in amount of depth-of-cut to achieve high machining accuracy.

The present disclosure has been described on the basis of the examples. It is to be understood by those skilled in the art that the examples are illustrative and that various modifications are possible for a combination of components or processes, and that such modifications are also within the scope of the present disclosure. According to the embodiment, the laser unit 16 in the cutting edge machining apparatus 10 emits two rays of laser light, but may emit three or more rays of laser light. On the other hand, when the finishing accuracy required for cutting is not high in the integrated part 111 of the cutting edge machining apparatus 10, the laser unit 16 may use a single ray of laser light to machine, for example, only the flank face that highly affects the finishing accuracy of cutting process.

An outline of aspects of the present disclosure is as follows. A cutting edge machining apparatus according to one aspect of the present disclosure is structured to laser-machine a cutting part of a cutting tool and includes a first optical member structured to form a first optical path of laser light, a second optical member structured to form a second optical path of laser light, a motion mechanism structured to move a cutting edge of the cutting part relative to the first optical path and the second optical path, and a controller structured to control relative movement made by the motion mechanism. The controller causes the motion mechanism to move the cutting edge relative to the first optical path to machine a flank face of the cutting edge with laser light passing through the first optical path. The controller further causes the motion mechanism to move the cutting edge relative to the second optical path to machine a rake face of the cutting edge with laser light passing through the second optical path.

Using the laser light that passes through two different optical paths to machine the flank face of the cutting edge and the rake face of the cutting edge brings about an advantage of eliminating the need for a mechanism that changes the tool orientation.

The controller may cause the motion mechanism to simultaneously move the cutting edge relative to the first optical path and the second optical path to simultaneously machine the flank face of the cutting edge and the rake face of the cutting edge. This makes it possible to shorten the laser-machining time. It is preferable that at least one of the rays of laser light passing through the first optical path and the second optical path travel in a direction from a root side of the cutting part toward a tip side of the cutting part. In particular, in pulse laser grinding, high-precision machining can be achieved by causing the laser light to travel in the direction from the root side of the cutting part to the tip side of the cutting part. Note that it is preferable that both the rays of laser light passing through the first optical path and the second optical path each travel in the direction from the root side of the cutting part to the tip side of the cutting part.

Another aspect of the present disclosure is a cutting apparatus. This apparatus includes a motion mechanism structured to move a cutting edge of a cutting tool relative to a workpiece, and a controller structured to control movement, made by the motion mechanism, of the cutting edge of the cutting tool relative to the workpiece. The cutting apparatus further includes a laser light source structured to emit laser light for use in laser-machining the cutting edge of the cutting tool, and an optical member structured to form an optical path of laser light. The controller causes the motion mechanism to move the cutting edge relative to the optical path to laser-machine the cutting edge.

When the cutting apparatus has a laser-machining capability of sharpening a cutting part, it is possible to sharpen, when the cutting edge is worn, the cutting edge without detaching the cutting tool from the cutting apparatus. It is preferable that the laser-machining capability allow the flank face of the cutting edge and the rake face of the cutting edge to be machined by using the laser light passing through two different optical paths. It is preferable that the controller cause the motion mechanism to move the cutting edge relative to the optical path while maintaining the cutting orientation of the cutting tool to laser-machine the cutting edge.

1. A cutting edge machining apparatus structured to laser-machine a cutting part of a cutting tool, the cutting edge machining apparatus comprising:
a first optical member structured to form a first optical path of laser light;
a second optical member structured to form a second optical path of laser light;
a motion mechanism structured to move a cutting edge of the cutting part relative to the first optical path and the second optical path; and
a controller structured to control relative movement made by the motion mechanism, wherein
a relative angle between the first optical path and the second optical path is set to form an angle between a flank face and a rake face after being machined,
the controller causes the motion mechanism to move the cutting edge relative to the first optical path to machine the flank face of the cutting edge with laser light passing through the first optical path, and
the controller causes the motion mechanism to move the cutting edge relative to the second optical path to machine the rake face of the cutting edge with laser light passing through the second optical path.

2. The cutting edge machining apparatus according to claim 1, wherein
the controller causes the motion mechanism to simultaneously move the cutting edge relative to the first optical path and the second optical path to simultaneously laser-machine the flank face of the cutting edge and the rake face of the cutting edge.

3. The cutting edge machining apparatus according to claim 1, further comprising:
a laser light source structured to emit the laser light; and
a beam splitter structured to split the laser light emitted into the first optical path and the second optical path.

4. The cutting edge machining apparatus according to claim 1, wherein
the laser light passing through at least either the first optical path or the second optical path travels in a direction from a root side of the cutting part toward a tip side of the cutting part.

5. The cutting edge machining apparatus according to claim 4, wherein
both the laser light passing through the first optical path and the laser light passing through the second optical path travel in the direction from the root side of the cutting part to the tip side of the cutting part.

6. The cutting edge machining apparatus according to claim 1, wherein
the controller scans a cylindrical irradiation region including a focused spot of the laser light to machine the flank face of the cutting edge and the rake face of the cutting edge.

7. A cutting apparatus comprising:
a motion mechanism structured to move a cutting edge of a cutting tool relative to a workpiece; and
a controller structured to control relative movement, made by the motion mechanism, between the workpiece and the cutting edge of the cutting tool, the cutting apparatus further comprising:
a laser light source structured to emit laser light for use in laser-machining the cutting edge of the cutting tool; and
an optical member structured to form an optical path of laser light, wherein the controller causes the motion mechanism to move the
cutting edge relative to the optical path to laser-machine the cutting edge.

8. The cutting apparatus according to claim 7, wherein
the controller causes the motion mechanism to move the cutting edge relative to the optical path while maintaining a cutting orientation of the cutting tool to laser-machine the cutting edge.
